(19) United States
(12) Patent Application Publication
(10) Pub. No.: US 2007/0035126 A1
(43) Pub. Date: Feb. 15, 2007

(54) Sprinkler head connector system

(76) Inventors: James Hickey, Kennesaw, GA (US); Steven James Brinson, Panama City Beach, FL (US)

Correspondence Address: SUTHERLAND ASBILL & BRENNAN LLP, 999 PEACHTREE STREET, N.E., ATLANTA, GA, 30309, US

(21) Appl. No.: 11/202,775

(22) Filed: Aug. 12, 2005

(51) Int. Cl. B05B 15/06; F16L 27/00

(52) U.S. Cl. 285/282; 239/587.1; 239/201

(57) ABSTRACT

A sprinkler connection system that includes a pipe connector for interfacing a sprinkler pipe, a sprinkler head connector for interfacing a sprinkler head and an interface between the pipe connector and the sprinkler head connector such that the head connector can rotate in a first direction relative to the pipe connector but is prevented from rotating in a second rotation relative to the pipe connector. The pipe connector may include gear teeth oriented in a first direction and the sprinkler head connector may include gear teeth oriented in a second direction such that the sprinkler head connector may rotate in the first direction with respect to the pipe connector but cannot rotate in the second direction with respect to the pipe connector.

### TECHNICAL FIELD

This invention relates to sprinkler head connectors, and more particularly relates to sprinkler head connectors that can be used to adjust the rotational angle of the sprinkler head.

### BACKGROUND OF THE INVENTION

Sprinkler systems are widely used on both commercial and residential properties to hydrate lawns, plants, trees, and flower beds. Large volumes of water are used from either wells or city water supplies to provide the requisite hydration to the vegetation. To adequately water the vegetation, the sprinkler heads must be uniformly positioned to apply the appropriate amount of water to any given location. The amount of water provided may be controlled through the duration of the sprinkler cycles and/or spray angles of the sprinkler heads.

To adjust the angle of the sprinkler head, users often physically turn the sprinkler head with respect to the sprinkler piping system. For example, if the sprinkler needs to be angled more to the right, the user may overtighten the sprinkler head to turn it to the desired angle. Overtightening, however, can cause problems such as breaking and cracking the piping or the sprinkler head itself. Conversely, if the rotational angle needs to be more to the left, the user may loosen the sprinkler head. Loosening the sprinkler head has the disadvantage of breaking any seal that may have been formed from a taut connection between the sprinkler head and the sprinkler pipe. In either scenario, water may then leak from the sprinkler pipe at the interface with the sprinkler head therefore possibly resulting in significant water loss.

Therefore, there is a need in the art for a system of positioning a sprinkler head at a desired rotational angle without breaking the seal formed between the sprinkler head and the sprinkler piping.

### SUMMARY OF THE INVENTION

According to an embodiment of the invention, there is a sprinkler connection system that includes a pipe connector for interfacing a sprinkler pipe, a sprinkler head connector for interfacing a sprinkler head and an interface between the pipe connector and the sprinkler head connector such that the head connector can rotate in a first direction relative to the pipe connector but is prevented from rotating in a second rotation relative to the pipe connector. In an aspect of the invention, the pipe connector includes gear teeth oriented in a first direction and the sprinkler head connector comprises gear teeth oriented in a second direction such that the sprinkler head connector may rotate in the first direction with respect to the pipe connector but cannot rotate in the second direction with respect to the pipe connector. The pipe connector may alternatively include a plurality of arms oriented in a first direction about the circumference of the pipe connector and the sprinkler head connector may include gear teeth oriented in a second direction such that the sprinkler head connector may rotate in the first direction with respect to the pipe connector but cannot rotate in the second direction with respect to the pipe connector.

In yet another aspect of the invention, the pipe connector and sprinkler head connector interface to create a substantial L-Shape or may be a substantially linear combination. In another aspect of the invention, the sprinkler connection system may be made of a plastic. In another aspect of the invention, the pipe connector is removably affixed to the sprinkler head connector through tabs located at the end of extensions protruding from the pipe connector, wherein the tabs secure the sprinkler head connector against the pipe connector.

Another embodiment of the invention may be a method for connecting the sprinkler head to the sprinkler pipe including the steps of connecting a pipe connector to the sprinkler pipe, connecting the sprinkler head to a sprinkler head connector such that the connection forms a seal to prevent water leakage, wherein the sprinkler head connector is affixed to the pipe connector, and rotating the sprinkler head connector with respect to the pipe connector to position the sprinkler head without breaking the seal. In one aspect of the method, the sprinkler head connector rotates with respect to the pipe connector through gear teeth.

Another embodiment of the invention may further include a sprinkler connection system including a pipe connector for interfacing a sprinkler pipe, a sprinkler head connector for interfacing a sprinkler head, gear teeth located on the pipe connector angled in a first direction, and gear teeth located on the sprinkler head connector angled in a second direction, wherein the gear teeth of the pipe connector interfaces with the gear teeth of the sprinkler head connector, wherein the sprinkler head connector is rotatable in the first direction with respect to the pipe connector but is not rotatable is the second direction with respect to the pipe connector.

### BRIEF DESCRIPTION OF DRAWINGS

Having thus described the invention in general terms, reference will now be made to the accompanying drawings, which are not necessarily drawn to scale, and wherein:

FIG. 1 is a perspective view of the sprinkler connection device according to an embodiment of the present invention.

FIG. 2 is an assembly view of the sprinkler connection device according to an embodiment of the present invention.

FIG. 3 is a perspective view of the sprinkler connection device connected to a sprinkler pipe and a sprinkler head according to an embodiment of the present invention.

FIG. 4 is a cross-sectional view of the gear teeth according to an embodiment of the present invention.

### DETAILED DESCRIPTION OF THE INVENTION

The present invention now will be described more fully hereinafter with reference to the accompanying drawings, in which exemplary embodiments of the invention are shown. This invention may, however, be embodied in many different forms and should not be construed as limited to the embodiments set forth herein; rather, these embodiments are provided so that this disclosure will be thorough and complete, and will convey the scope of the invention to those skilled in the art.

The present invention relates to systems and methods for interfacing a sprinkler head with a sprinkler water pipe so as to preserve a tight connection between the sprinkler water pipe and a sprinkler head and to allow for desired rotational positioning of the sprinkler head with relation to the sprinkler water pipe. The present invention is applicable to all types of sprinkler systems, sprinkler piping, and sprinkler heads.

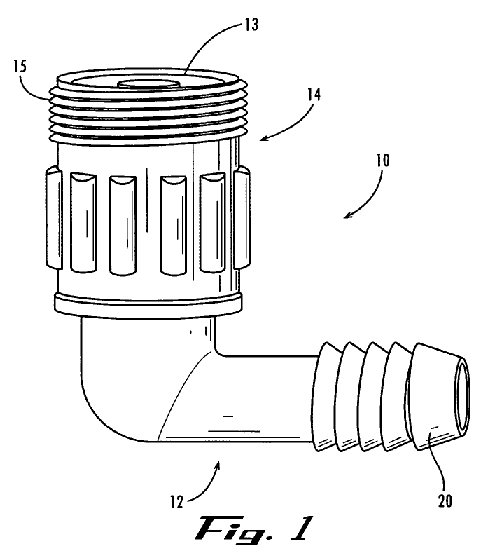

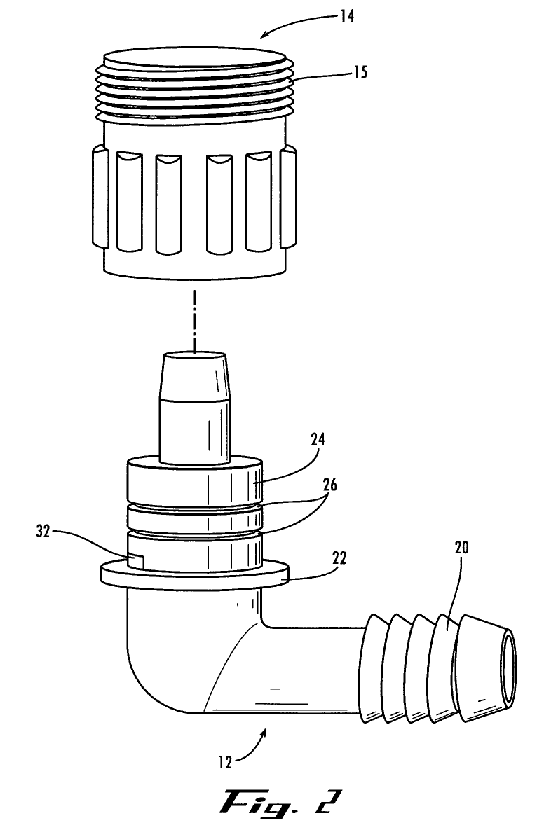

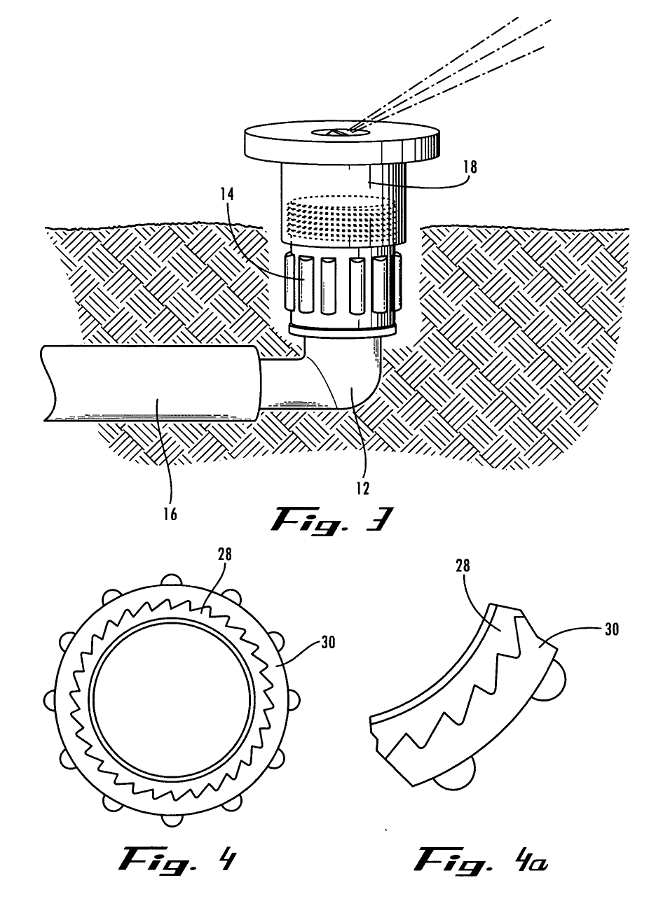

Exemplary embodiments of the present invention will hereinafter be described with reference to the figures, in which like numerals indicate like elements throughout the several drawings. FIGS. 1 and 2 illustrate a sprinkler head connector system 10 in accordance with embodiment of the present invention. The sprinkler head connector system 10 may include a pipe connector 12 and a sprinkler head connector 14. As illustrated in FIG. 3, the pipe connector 12 may connect with a sprinkler pipe 16 that carries water for the sprinkler system. One of ordinary sill in the art will appreciate that the sprinkler head connector system 10 may include a plurality of pipe connectors 12 for connection with a plurality of sprinkler pipes 16. The sprinkler head connector 14 may connect to a sprinkler head 18 which is used to expel water to the desired location. The combination of the pipe connector 12 and the sprinkler head connector 14 allows the water to pass from the sprinkler pipe 16 through the sprinkler head 18.

The pipe connector 12 and the sprinkler head connector 14 may be removably or permanently affixed to each other. In one illustrative embodiment, the pipe connector 12 includes a connection apparatus that projects vertically from the top of the pipe connector 12. In this embodiment, the connection apparatus includes two vertical extensions with holding tabs 13 on the end. The vertical extensions with the holding tabs 13 may extend into the sprinkler head 18 connector such that the holding tabs 13 secure the sprinkler head connector 14 to the pipe connector 12. One of ordinary skill in the art will appreciate that any apparatus may be used to affix the sprinkler head connector 14 with the pipe connector 12. One of ordinary skill in the art will also appreciate that the pipe connector 12 and the head connector 14 do not have to be two separate devices but may be any number of devices that may be connected together.

A distal end 20 of the pipe connector 12 may be used to connect with the sprinkler pipe 16. The distal end 20 of the pipe connector 12 may be configured to fit into or around the circumference of the sprinkler pipe 16. In the exemplary embodiment of FIG. 3, the circumference of the distal end 20 of the pipe connector 12 is smaller than the circumference of the sprinkler pipe 16 such that the distal end 20 will fit snugly inside of the sprinkler pipe 16. The distal end 20 of the pipe connector 12 may be staggered as is shown or threaded to screw into the sprinkler pipe 16. One of ordinary skill in the art will appreciate that the distal end 20 of the pipe connector 12 may have any configuration including being smooth, having ridges for added security, or having any other components that assist in connecting and sealing the pipe connector 12 to the sprinkler pipe 16.

The pipe connector 12 may include a surface 22 for interfacing the sprinkler head connector 14. In an exemplary embodiment, the surface 22 is a ring that extends outwardly from the pipe connector 12. A substantially tubular section 24 may protrude from the surface 22 to a proximate end of the pipe connector 12. The tubular section 24 may be substantially cylindrical in shape. The tubular section 24 may include an O-ring 26 for sealing. In an exemplary embodiment, the tubular section 24 includes at least one groove for positioning of the O-ring 26. One of ordinary skill in the art will appreciate that the pipe connector 12 may be any configuration that permits the sprinkler head 18 to interface the pipe connector 12 and is not limited to the embodiment described herein.

The pipe connector 12 is substantially hollow to allow sprinkler water to flow from the sprinkler pipes 16 through the pipe connector 12. One of ordinary skill in the art will appreciate that any configuration that allows fluid to pass from the distal end 29 to the proximate end of the pipe connector 12 is contemplated herein.

The sprinkler head connector 14 may engage the pipe connector 12 to allow a sprinkler head 18 to receive water from the sprinkler pipe 16. In an illustrative embodiment, the sprinkler head connector 14 may be cylindrically shaped. One of ordinary skill in the art will appreciate that the sprinkler head connector 14 may be any shape that may engage a sprinkler head 18. The sprinkler head connector 14 is substantially hollow to allow water to pass from the pipe connector 12 through the sprinkler head connector 14.

The proximate end of the sprinkler head connector 14 may include threads 15 on the outside circumference such that a sprinkler head 18 with a threaded bottom portion may be screwed onto the sprinkler head connector 14. The sprinkler head 18 may be screwed onto the sprinkler head connector 14 while the sprinkler head connector 14 is affixed to the pipe connector 12 to form a seal. However, any other connection means is contemplated herein.

The pipe connector 12 and the sprinkler head connector 14 may interface each other such that the sprinkler head connector 14 can rotate in a first direction with respect to the pipe connector 12 but cannot rotate in a second direction with respect to the pipe connector 12. The sprinkler head connector 14 is rotatable in the first direction to allow the sprinkler head 18 to be positioned at a desired angle. As illustrated in FIG. 4, in an exemplary embodiment, the pipe connector 12 and the sprinkler head connector 14 include gear teeth 28 to control the rotation of the sprinkler head connector 14 in relation to the pipe connector 12. The tubular section 24 of the pipe connector 12 may include gear teeth 28 and the inside circumference of the distal end of the sprinkler head connector 14 may include gear teeth 28 for engaging the gear teeth 28 of the pipe connector 12. The gear teeth 28 of the pipe connector 12 may be angled in a first direction and the gear teeth 30 of the sprinkler head connector 14 may be angled in the second direction, such that when the sprinkler head connector 14 engages the pipe connector 12, the gear teeth 28, 30 allow the sprinkler head connector 14 to rotate in the first direction. However, the gear teeth 28 of the pipe connector 12 will prevent rotation in the second direction because the vertical surface 22 of the gear teeth 30 of the sprinkler head connector 14 will abut the vertical surface 22 of the gear teeth 28 of the pipe connector 12. For example, the sprinkler head connector 14 may rotate freely with a left rotation but is prevented from rotating in the right rotation. Therefore, a user can tighten the sprinkler head 18 into the sprinkler head connector 14 by rotating the sprinkler head 18 to the right and thereby forming a seal that prevents leaking. The user then may rotate or ratchet back the sprinkler head connector 14 to the left to a desired angle without breaking the seal. In another exemplary embodiment, the pipe connector 12 may include at least one arm 32 angled in the first direction to engage the gear teeth 30 of the sprinkler head connection 14. The angled arm 32 may be substantially rectangular in shape and extend from the circumference of the pipe connector. The angled arm 32 will allow the gear teeth 28 to rotate in the first direction but will prevent rotation in the second direction. One of ordinary skill in the art will appreciate that any interface device may be used that allows the rotation of the sprinkler head connector 14 in a first direction with respect to the pipe connector 12 but prevents rotation in a second direction and is not limited to the use of gear teeth or gear teeth 28, 30 as set forth in these embodiments.

The sprinkler head connection system 10 may be made of any material suitable for use with sprinkler systems including plastics and metals. Further, the sprinkler head connector system 10 may be any shape that permits the sprinkler head 18 to be available in a desired location. For example, if the sprinkler pipe resides substantially horizontal in the ground, the sprinkler head connector system 10 may have a substantially L-shape as depicted in FIGS. 1 through 3. Conversely, if the sprinkler pipe 16 resides vertically in the ground, the sprinkler head connector system 10 may be substantially linear in shape. One of ordinary skill in the art will appreciate that the sprinkler head connector system 10 may be any shape depending on the angle of the sprinkler pipe 16 and the desired orientation of the sprinkler head 18 that attaches to the sprinkler head connector system 10.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in generic and descriptive sense only and not for purposes of limitation.

That which is claimed:

1. A sprinkler connection system comprising:
a pipe connector for interfacing a sprinkler pipe;
a sprinkler head connector for interfacing a sprinkler head; and
an interface between the pipe connector and the sprinkler head connector, wherein the head connector can rotate in a first direction relative to the pipe connector but is prevented from rotating in a second rotation relative to the pipe connector.

2. The system of claim 1, wherein the interface comprises a gear system.

3. The gear system of claim 2, wherein the pipe connector comprises gear teeth oriented in a first direction and the sprinkler head connector comprises gear teeth oriented in a second direction such that the sprinkler head connector may rotate in the first direction with respect to the pipe connector but cannot rotate in the second direction with respect to the pipe connector.

4. The system of claim 3, wherein the pipe connector comprises a plurality of arms oriented in a first direction about the circumference of the pipe connector and the sprinkler head connector comprises gear teeth oriented in a second direction such that the sprinkler head connector may rotate in the first direction with respect to the pipe connector but cannot rotate in the second direction with respect to the pipe connector.

5. The system of claim 1, wherein the pipe connector and sprinkler head connector interface to create a substantial L-Shape.

6. The system of claim 1, wherein the sprinkler connection system comprises a plastic.

7. The system of claim 1, wherein the pipe connector and sprinkler head connector interface in a substantially linear combination.

8. The system of claim 1, wherein the pipe connector is removably affixed to the sprinkler head connector.

9. The system of claim 1, wherein the pipe connector is removably affixed to the sprinkler head connector through tabs located at the end of extensions protruding from the pipe connector, wherein the tabs secure the sprinkler head connector against the pipe connector.

10. A method for connecting a sprinkler head to a sprinkler pipe comprising the steps of:
connecting a pipe connector to the sprinkler pipe;
connecting the sprinkler head to a sprinkler head connector such that the connection forms a seal to prevent water leakage, wherein the sprinkler head connector is affixed to the pipe connector; and
rotating the sprinkler head connector with respect to the pipe connector to position the sprinkler head without breaking the seal.

11. The method of claim 10, wherein the sprinkler head connector rotates with respect to the pipe connector through gear teeth.

12. A sprinkler connection system comprising:
a pipe connector for interfacing a sprinkler pipe;
a sprinkler head connector for interfacing a sprinkler head;
gear teeth located on the pipe connector angled in a first direction;
gear teeth located on the sprinkler head connector angled in a second direction, wherein the gear teeth of the pipe connector interfaces with the gear teeth of the sprinkler head connector, wherein the sprinkler head connector is rotatable in the first direction with respect to the pipe connector but is not rotatable is the second direction with respect to the pipe connector.

13. The system of claim 12 comprising plastic.

14. The system of claim 12, wherein the pipe connector is removably affixed to the sprinkler head connector.
